(19) United States
(12) Patent Application Publication
(10) Pub. No.: US 2023/0330781 A1
(43) Pub. Date: Oct. 19, 2023

(54) WAFER MANUFACTURING METHOD

(71) Applicant: DISCO CORPORATION, Tokyo (JP)

(72) Inventor: Yoshinobu SAITO, Tokyo (JP)

(21) Appl. No.: 18/298,749

(22) Filed: Apr. 11, 2023

(30) Foreign Application Priority Data
Apr. 18, 2022 (JP) 2022-068359

(51) Int. Cl. B23K 26/38; B23K 26/352

(52) U.S. Cl. CPC B23K 26/38; B23K 26/352; B23K 2101/40

(57) ABSTRACT

A wafer manufacturing method includes forming a first peel-off layer in an ingot by applying a laser beam with a focused spot of the laser beam in the ingot at a first depth from an end face of the ingot for fabricating a larger-diameter wafer, forming a second peel-off layer in the ingot for fabricating a smaller-diameter wafer by applying the laser beam to an area of the ingot that is smaller in diameter than the ingot while positioning the focused spot in the ingot at a second depth, which is smaller than the first depth, from the end face of the ingot, and forming an annular first separating wall along an outer circumferential edge of the smaller-diameter wafer by applying the laser beam to the ingot while positioning the focused spot on an annular area extending from the end face of the ingot to the second peel-off layer.

### BACKGROUND OF THE INVENTION

### Field of the Invention

The present invention relates to a wafer manufacturing method of manufacturing a wafer.

### Description of the Related Art

A plurality of devices such as integrated circuits (ICs) and large-scale integration (LSI) circuits are produced by overlaying a functional layer on a face side of a wafer made of silicon, sapphire, or the like and demarcating a plurality of areas including the devices on the functional layer with a grid of intersecting projected dicing lines. The wafer is then processed along the projected dicing lines by a cutting apparatus or a laser processing apparatus and divided into individual device chips that have the respective devices. The device chips thus fabricated from the wafer will be used in various electronic appliances including cellular phones, personal computers, etc.

Power devices, light emitting diodes (LEDs), etc. are produced by overlaying a functional layer on a face side of a wafer made of silicon carbide (SiC) and demarcating a plurality of areas including the power devices, LEDs, etc. on the functional layer with a grid of intersecting projected dicing lines.

Wafers on which devices, power devices, LEDs, etc. as describe above are to be constructed are generally sliced from ingots by a wire saw (see, for example, Japanese Patent Laid-open No. 2000-094221), and then have their face and reverse sides polished to a mirror finish.

However, the slicing and polishing processing is not economical because, when a wafer blank is sliced from an ingot by a wire saw and then polished on its face and reverse sides into a wafer, 70% through 80% of the material of the ingot are wasted. In addition, ingots of SiC are so hard that they are difficult to cut by a wire saw, hence have poor productivity, pose a high unit price, and are unable to produce wafers efficiently.

In view of the above difficulties, there has been proposed by the present applicant a technology in which a laser beam that has a wavelength transmittable through SiC is applied to an SiC ingot while positioning a focused spot of the laser beam within the SiC ingot, thereby creating a separating layer in the SiC ingot at a projected severance plane, and then a wafer is separated from the ingot along the separating layer at the projected severance plane, so that any waste of the ingot material will be minimized (see, for example, Japanese Patent Laid-open No. 2016-111143).

### SUMMARY OF THE INVENTION

However, even according to the technology disclosed in Japanese Patent Laid-open No. 2016-111143, after a plurality of devices have been constructed on a face side of a wafer sliced from an SiC ingot, the wafer has its reverse side ground to reduce its thickness of 800 µm, for example, to a thickness ranging from 50 to 100 µm. Since as much wafer material as a wafer thickness of at least 700 µm is wasted, the disclosed processing still remains uneconomical.

It is therefore an object of the present invention to provide a wafer manufacturing method that can efficiently manufacture wafers and achieve economical wafer manufacturing.

In accordance with an aspect of the present invention, there is provided a wafer manufacturing method of manufacturing a wafer from an ingot, including a first peel-off layer forming step of forming a first peel-off layer in the ingot by applying a laser beam having a wavelength transmittable through the ingot while positioning a focused spot of the laser beam in the ingot at a first depth from an end face of the ingot for fabricating a larger-diameter wafer, a second peel-off layer forming step of forming a second peel-off layer in the ingot for fabricating a smaller-diameter wafer by applying the laser beam to an area of the ingot that is smaller in diameter than the ingot while positioning the focused spot in the ingot at a second depth, which is smaller than the first depth, from the end face of the ingot, a separating wall forming step of forming an annular first separating wall along an outer circumferential edge of the smaller-diameter wafer by applying the laser beam to the ingot while positioning the focused spot on an annular area extending from the end face of the ingot to the second peel-off layer, and a wafer fabricating step of peeling off the larger-diameter wafer from the first peel-off layer and separating the smaller-diameter wafer from the second peel-off layer and the first separating wall.

Preferably, the second peel-off layer formed in the second peel-off layer forming step is also formed in an area of the ingot that is larger in diameter than the smaller-diameter wafer to be fabricated and that is positioned diametrically inward of an annular stiffener formed on an outer circumferential portion of the larger-diameter wafer to be fabricated, the separating wall forming step includes a step of forming an annular second separating wall along an inner circumferential edge of the annular stiffener in addition to the first separating wall, and the wafer fabricating step includes a step of fabricating a ring-shaped wafer from an area of the ingot between the smaller-diameter wafer and the annular stiffener. Preferably, the smaller-diameter wafer has a standardized diameter.

Preferably, the wafer manufacturing method further includes a first alignment mark forming step of forming a first alignment mark inside or outside of the larger-diameter wafer that will be required in constructing circuits on the larger-diameter wafer to be fabricated, before or after the first peel-off layer forming step, and a second alignment mark forming step of forming a second alignment mark inside or outside of the smaller-diameter wafer that will be required in constructing circuits on the smaller-diameter wafer to be fabricated, before or after the second peel-off layer forming step.

In accordance with another aspect of the present invention, there is provided a wafer manufacturing method of manufacturing a smaller-diameter wafer from a larger-diameter wafer having a plurality of devices formed on a face side thereof, including a smaller-diameter peel-off layer forming step of forming a smaller-diameter peel-off layer in the smaller-diameter wafer to be fabricated, by applying a laser beam having a wavelength transmittable through the larger-diameter wafer while positioning a focused spot of the laser beam in the larger-diameter wafer at a depth from a reverse side thereof, the depth corresponding to a thickness of the smaller-diameter wafer to be fabricated, a smaller-diameter separating wall forming step of forming an annular smaller-diameter separating wall in the larger-diameter wafer along an outer circumferential edge of the smaller-diameter wafer by applying the laser beam to the larger-diameter wafer while positioning the focused spot on an annular area extending from the reverse side of the larger-diameter wafer to the smaller-diameter peel-off layer, and a smaller-diameter wafer fabricating step of separating the smaller-diameter wafer from the smaller-diameter peel-off layer and the smaller-diameter separating wall.

Preferably, the smaller-diameter peel-off layer formed in the smaller-diameter peel-off layer forming step is also formed in an area of the larger-diameter wafer that is larger in diameter than the smaller-diameter wafer to be fabricated and that is positioned diametrically inward of an annular stiffener formed on an outer circumferential portion of the larger-diameter wafer to be fabricated, the smaller-diameter separating wall forming step includes a step of forming an annular separating wall along an inner circumferential edge of the annular stiffener in addition to the smaller-diameter separating wall along the outer circumferential edge of the smaller-diameter wafer, and the wafer fabricating step includes a step of fabricating a ring-shaped wafer from an area of the larger-diameter wafer between the smaller-diameter wafer and the annular stiffener, in addition to the smaller-diameter wafer. Preferably, the wafer manufacturing method further includes an alignment mark forming step of forming an alignment mark inside or outside of the smaller-diameter wafer that will be required in constructing circuits on the smaller-diameter wafer to be fabricated, before or after the smaller-diameter peel-off layer forming step.

The wafer manufacturing method according to the aspect of the present invention is advantageous in that it prevents the material of the ingot from being wasted because the smaller-diameter wafer that is smaller in diameter than the larger-diameter wafer can be manufactured. In addition, it is also possible to fabricate another smaller-diameter wafer from the smaller-diameter wafer according to a wafer manufacturing method similar to the above method performed on the smaller-diameter wafer. The material of the ingot is thus further prevented from being wasted.

Moreover, the wafer manufacturing method according to the other aspect of the present invention is advantageous in that it can manufacture wafers economically because the reverse side of the larger-diameter wafer with the devices constructed in the respective areas demarcated on the facer side by the projected dicing lines is not ground, but the laser beam is applied to the larger-diameter wafer from the reverse side thereof to form the smaller-diameter peel-off layer, making it possible to fabricate the smaller-diameter wafer having the thickness that would otherwise be wasted.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a laser processing apparatus that carries out a wafer manufacturing method according to a first embodiment of the present invention;

FIG. 2A is a perspective view illustrating a manner in which a first peel-off layer forming step of the wafer manufacturing method according to the first embodiment is performed;

FIG. 2B is a side elevational view illustrating the manner in which the first peel-off layer forming step is performed as illustrated in FIG. 2A;

FIG. 3A is a perspective view illustrating a manner in which a second peel-off layer forming step of the wafer manufacturing method according to the first embodiment is performed;

FIG. 3B is a side elevational view illustrating the manner in which the second peel-off layer forming step is performed as illustrated in FIG. 3A;

FIG. 4A is a perspective view illustrating a manner in which a separating wall forming step of the wafer manufacturing method according to the first embodiment is performed;

FIG. 4B is a side elevational view illustrating the manner in which the separating wall forming step is performed as illustrated in FIG. 4A;

FIGS. 5A and 5B are perspective views illustrating a manner in which an alignment mark forming step of the wafer manufacturing method according to the first embodiment is performed;

FIG. 6 is a perspective view illustrating a manner in which a wafer fabricating step of the wafer manufacturing method according to the first embodiment is performed;

FIG. 7A is a perspective view illustrating a manner in which a second peel-off layer forming step of a wafer manufacturing method according to a second embodiment of the present invention is performed;

FIG. 7B is a side elevational view illustrating the manner in which the second peel-off layer forming step is performed as illustrated in FIG. 7A;

FIG. 8A is a perspective view illustrating a manner in which a separating wall forming step of the wafer manufacturing method according to the second embodiment is performed;

FIG. 8B is a side elevational view illustrating the manner in which the separating wall forming step is performed as illustrated in FIG. 8A;

FIG. 9 is a perspective view illustrating a manner in which a wafer fabricating step of the wafer manufacturing method according to the second embodiment is performed;

FIG. 10 is a perspective view illustrating a manner in which a smaller-diameter peel-off layer forming step of a wafer manufacturing method according to a third embodiment of the present invention is performed; and

FIG. 11 is a perspective view illustrating a manner in which a wafer fabricating step of the wafer manufacturing method according to the third embodiment is performed.

### DETAILED DESCRIPTION OF THE PREFERRED EMBODIMENTS

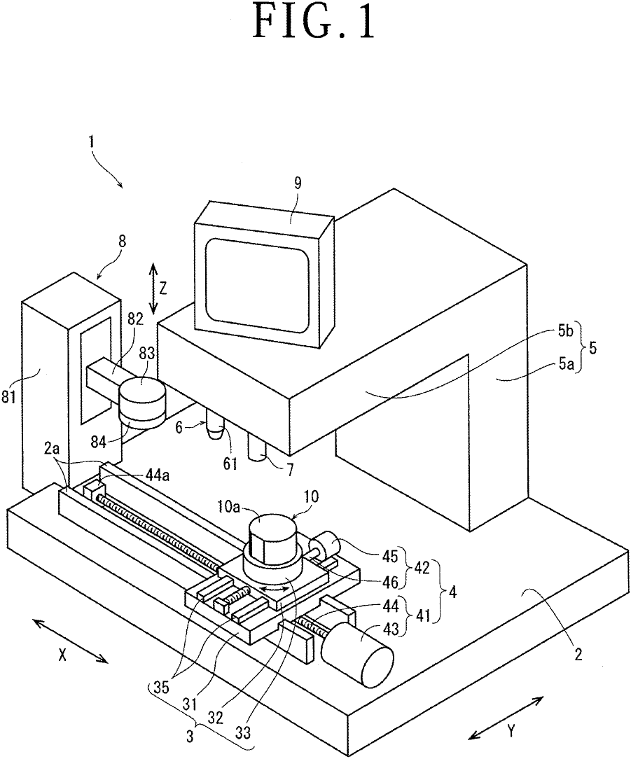

Wafer manufacturing methods according to preferred embodiments of the present invention will be described hereinbelow with reference to the accompanying drawings. FIG. 1 illustrates in perspective a laser processing apparatus 1 that carries out a wafer manufacturing method according to a first embodiment of the present invention. The laser processing apparatus 1 includes a base 2, a holding unit 3 disposed on the base 2 for holding a workpiece thereon, a moving mechanism 4 for moving the holding unit 3 along an X-axis and a Y-axis perpendicular to the X-axis, a laser beam applying unit 6, an image capturing unit 7 for performing alignment processing, and a wafer peeling unit 8. Directions along the X-axis, the Y-axis, and a Z-axis that extends perpendicularly to the X-axis and the Y-axis are referred to as X-axis directions, Y-axis directions, and Z-axis directions along which some components of the laser processing apparatus 1 are movable.

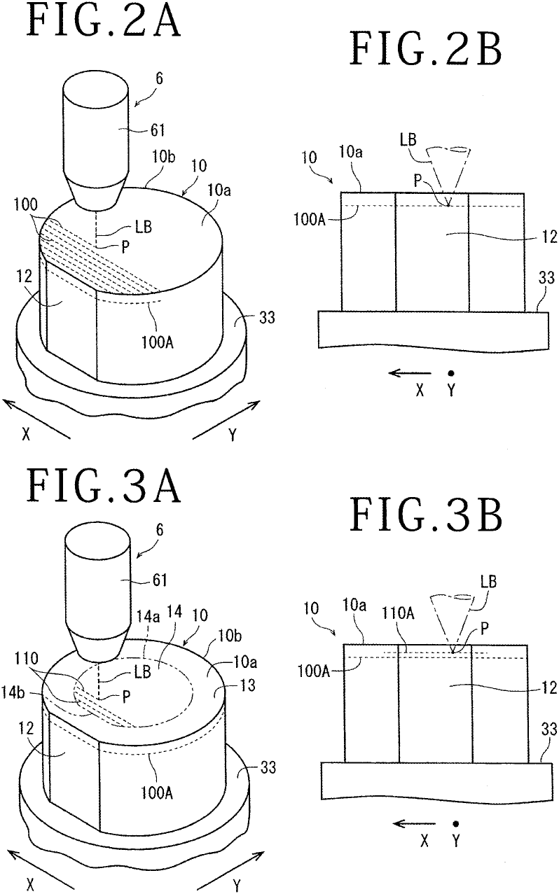

As illustrated in FIG. 1, the holding unit 3 includes an X-axis movable plate 31 shaped as a rectangular plate movably mounted on the base 2 for movement in the X-axis directions, a Y-axis movable plate 32 shaped as a rectangular plate movably mounted on the X-axis movable plate 31 for movement in the Y-axis directions, and a holding table 33 rotatably mounted on the Y-axis movable plate 32 and rotatable about its central axis parallel to the Z-axis by a stepping motor housed in the holding table 33. The workpiece to be held by the holding unit 3 and processed by the laser processing apparatus 1 is an ingot 10 of SiC illustrated in FIGS. 1, 2A, and 2B.

The moving mechanism 4 includes an X-axis moving mechanism 41 for moving the holding table 33 in the X-axis directions and a Y-axis moving mechanism 42 for moving the holding table 33 in the Y-axis directions. The X-axis moving mechanism 41 converts rotary motion of an electric motor 43 into linear motion through a ball screw 44 having an end supported by a bearing block 44a and transmits the linear motion to the X-axis movable plate 31, thereby moving the X-axis movable plate 31 in the X-axis directions along a pair of guide rails 2a mounted on the base 2 and extending along the X-axis. The Y-axis moving mechanism 42 converts rotary motion of an electric motor 45 into linear motion through a ball screw 46 and transmits the linear motion to the Y-axis movable plate 32, thereby moving the Y-axis movable plate 32 in the Y-axis directions along a pair of guide rails 35 mounted on the X-axis movable plate 31 and extending along the Y-axis.

The laser processing apparatus 1 includes a frame 5 having a vertical wall 5a erected on the base 2 laterally of the X-axis moving mechanism 41 and the Y-axis moving mechanism 42 and a horizontal wall 5b extending horizontally from an upper end portion of the vertical wall 5a in overhanging relation to the X-axis moving mechanism 41 and the Y-axis moving mechanism 42. The horizontal wall 5b of the frame 5 houses therein an optical system of the laser beam applying unit 6 and part of the image capturing unit 7. Although not described in detail, the optical system of the laser beam applying unit 6 includes a laser oscillator, not illustrated, for emitting a laser beam LB having a desired wavelength, an attenuator, not illustrated, for adjusting an output level of the laser beam LB emitted from the laser oscillator, and a reflecting mirror, not illustrated, for reflecting the laser beam LB from the attenuator toward a beam condenser 61 that has a condensing lens, not illustrated. The laser processing apparatus 1 also includes a controller, not illustrated, for controlling a repetitive frequency, a spot diameter, and an average output level of the laser beam LB applied by the laser beam applying unit 6, and also controlling the position of a focused spot of the laser beam LB in vertical directions, i.e., the Z-axis directions along the Z-axis, perpendicular to a holding surface provided by an upper surface of the holding table 33.

The wafer peeling unit 8 is disposed on the base 2 in the vicinity of terminal ends of the guide rails 2a that are close to the bearing block 44a. The wafer peeling unit 8 includes a peeling unit case 81, a peeling unit arm 82 having a proximal end portion housed in the peeling unit case 81 and movably supported thereby for upward and downward movement along the Z-axis, a peeling stepping motor 83 disposed on a distal end of the peeling unit arm 82, and a suction disk 84 rotatably supported on a lower portion of the peeling stepping motor 83 and rotatable about its central axis by the peeling stepping motor 83, the suction disk 84 having a plurality of suction holes defined in a lower surface thereof. The peeling unit case 81 houses therein a Z-axis moving mechanism, not illustrated, for moving the peeling unit arm 82 vertically along the Z-axis. The peeling unit case 81 is combined with a Z-axis position detector, not illustrated, for detecting the position of the peeling unit arm 82 along the Z-axis and sending a signal representing the detected position of the peeling unit arm 82 to the controller.

The controller is constituted by a computer including a central processing unit (CPU) for performing processing sequences according to control programs, a read only memory (ROM) storing the control programs, etc., a read/write random access memory (RAM) for temporarily storing detected values, results of the processing sequences, etc., and an input interface and an output interface. Details of the controller are omitted from description. The laser beam applying unit 6, the image capturing unit 7, the X-axis moving mechanism 41, the Y-axis moving mechanism 42, the wafer peeling unit 8, and a monitor 9 mounted on an upper surface of the horizontal wall 5b, etc. are electrically connected to the controller and controlled by the controller.

The laser processing apparatus 1 is generally of the structure described above. Laser processing methods carried out by the laser processing apparatus 1 will be described below.

First, the wafer manufacturing method according to the first embodiment, which is carried out by the laser processing apparatus 1, will be described in detail below.

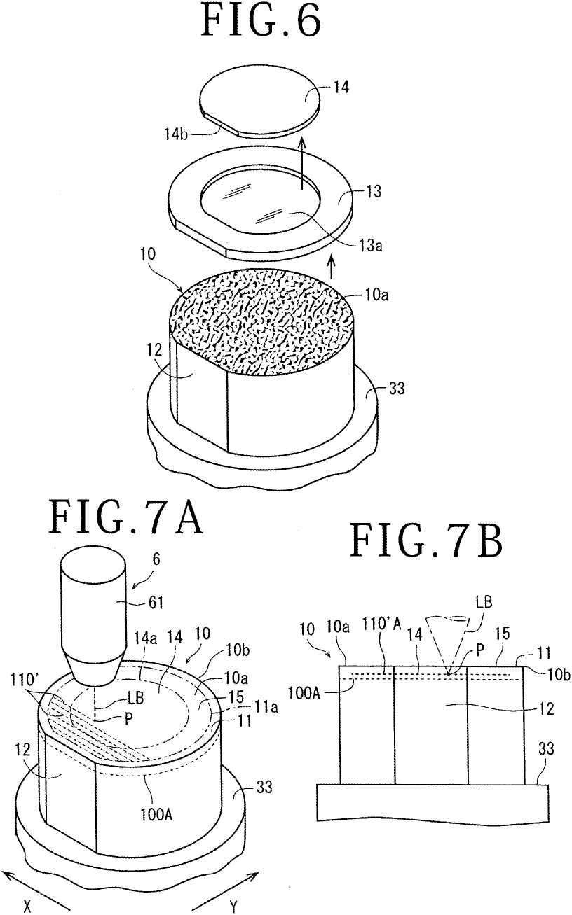

Prior to carrying out the wafer manufacturing method according to the first embodiment, the ingot 10 illustrated in FIGS. 1, 2A, and 2B is prepared. The ingot 10 is made of SiC and is a hexagonal monocrystalline ingot having a diameter of 300 mm. The ingot 10 has an end face as a face side 10a polished to a mirror finish by separate polishing means. From the ingot 10, there will be fabricated a disk-shaped larger-diameter wafer 13 (see FIG. 6) having a diameter of 300 mm and a disk-shaped smaller-diameter wafer 14 (see FIG. 6) having a diameter of 200 mm. The diameters of the larger-diameter wafer 13 and the smaller-diameter wafer 14 are dimensions according to the Semiconductor Equipment and Materials International (SEMI) Standards that have been established to unify international industrial standards for the semiconductor industry. The ingot 10 has an orientation flat 12 on its outer circumferential surface as an indicator of its crystal orientation.

A first peel-off layer forming step of the wafer manufacturing method according to the first embodiment is performed as follows: The ingot 10 is placed on the upper surface, i.e., the holding surface, of the holding table 33 of the laser processing apparatus 1. The ingot 10 is firmly secured to the holding surface by a bonding agent, a wax, or the like. Then, the image capturing unit 7 captures an image of the face side 10a of the ingot 10 and performs alignment processing for detecting the height of the face side 10a and the shape of a contour 10b of the ingot 10 from the captured image. Information representing the height of the face side 10a and the shape of the contour 10b is stored in the controller.

After the information representing the height of the face side 10a and the shape of the contour 10b has been stored in the controller, the holding table 33 is rotated to bring a direction represented by a straight area of an outer circumferential surface of the ingot 10 that represents the orientation flat 12 into alignment with the X-axis, and is moved along the X-axis to a position directly below the beam condenser 61 of the laser beam applying unit 6. Then, as illustrated in FIGS. 2A and 2B, the laser beam applying unit 6 applies the laser beam LB to the ingot 10 from the face side 10a thereof while positioning a focused spot P of the laser beam LB, whose wavelength is transmittable through the ingot 10, at a first depth of 800 µm, for example, from the face side 10a of the ingot 10 for the fabrication of the larger-diameter wafer 13 (see FIG. 3A). While the ingot 10 is being processing-fed in one of the X-axis directions, the laser beam LB is continuously applied to the ingot 10 fully across the face side 10a, thereby forming a modified layer 100 at the first depth in the ingot 10. The modified layer 100 has a starting end and a terminal end that are positioned on the outer circumferential surface of the ingot 10. After the modified layer 100 has been formed at the first depth in the ingot 10, the ingot 10 is indexing-fed in one of the Y-axis directions by a distance of 400 µm, for example. Then, while the focused spot P of the laser beam LB is being positioned at the first depth from the face side 10a of the ingot 10, and the ingot 10 is being processing-fed in one of the X-axis directions, the laser beam LB is continuously applied to the ingot 10, thereby forming a next modified layer 100 at the first depth in the ingot 10 parallel to the previously formed modified layer 100. The above processing is repeated until a plurality of modified layers 100 are formed at the first depth in the ingot 10 from the face side 10a. The modified layers 100 thus formed at the first depth jointly make up a first peel-off layer 100A. The first peel-off layer forming step of the wafer manufacturing method according to the first embodiment is now completed. Laser processing conditions in the first peel-off layer forming step are as follows:

### Laser Processing Conditions in the First Peel-Off Layer Forming Step

Wavelength: 1064 nm
Average output level: 7 to 16 W
Repetitive frequency: 30 kHz
Pulse duration: 3 ns
Processing feed speed: 165 mm/s
Defocusing distance: 300 µm (for forming a first peel-off layer 100A at a depth of 800 µm from the face side 10a)

Although not described in detail, the ingot 10 has been fabricated in such a manner as to have a c-axis inclined a predetermined off-angle α in a direction perpendicular to the straight area representing the orientation flat 12 and a c-plane perpendicular to the c-axis. The c-plane is inclined the off-angle α to the face side 10a of the ingot 10. The off-angle α is 4°, for example. When the first peel-off layer forming step is carried out, cracks extend from modified layers 100 toward adjacent modified layers 100 along the c-plane, and the modified layers 100 and the cracks make up the first peel-off layer 100A, as illustrated in FIG. 2B.

After the first peel-off layer forming step has been carried out, a second peel-off layer forming step is carried out.

In the second peel-off layer forming step, as illustrated in FIGS. 3A and 3B, the laser beam applying unit 6 applies the laser beam LB to a smaller area of the ingot 10 whose diameter is smaller than the diameter of the larger-diameter wafer 13, which is the same as the diameter of 300 mm of the ingot 10, from the face side 10a thereof while positioning the focused spot P of the laser beam LB at a second depth of 700 µm, for example, which is smaller than the first depth of 800 µm, from the face side 10a of the ingot 10, thereby forming a second peel-off layer 110A in the ingot 10 for the fabrication of the smaller-diameter wafer 14.

As illustrated in FIG. 3A, the smaller area of the ingot 10 that is irradiated with the laser beam LB in the second peel-off layer forming step is of a circular shape having an outer circumferential edge 14a from which the smaller-diameter wafer 14 is to be fabricated that is smaller than the larger-diameter wafer 13 to be fabricated from the entire end face, i.e., face side 10a, of the ingot 10. The outer circumferential edge 14a is indicated by an imaginary line in FIG. 3A and cannot visually be observed in reality. Positional information of the outer circumferential edge 14a is stored in advance in the controller. The smaller-diameter wafer 14 will have an orientation flat 14b on its outer circumferential surface as an indicator of its crystal orientation, and the outer circumferential edge 14a includes a straight area representing the orientation flat 14b. The orientation flat 14b lies parallel to the orientation flat 12 of the ingot 10. In the second peel-off layer forming step, the beam condenser 61 of the laser beam applying unit 6 is positioned above the outer circumferential edge 14a on the face side 10a of the ingot 10 on the basis of the positional information of the outer circumferential edge 14a stored in the controller, and the focused spot P of the laser beam LB whose wavelength is transmittable through the ingot 10 is positioned at the second depth of 700 µm. While the ingot 10 is being processing-fed in one of the X-axis directions, the laser beam LB is continuously applied to the ingot 10 fully across the smaller area of the ingot 10, thereby forming a modified layer 110 at the second depth in the ingot 10. The modified layer 110 has a starting end and a terminal end that are positioned on the outer circumferential edge 14a of the smaller area of the ingot 10.

After the modified layer 110 has been formed at the second depth in the ingot 10, the ingot 10 is indexing-fed in one of the Y-axis directions by a distance of 400 µm, for example. Then, while the focused spot P of the laser beam LB is being positioned at the second depth from the face side 10a of the ingot 10, and the ingot 10 is being processing-fed in one of the X-axis directions, the laser beam LB is continuously applied to the ingot 10, thereby forming a next modified layer 110 at the second depth in the ingot 10 parallel to the previously formed modified layer 110. The above processing is repeated until a plurality of modified layers 110 are formed at the second depth in the area of the ingot 10 diametrically inward of the outer circumferential edge 14a from the face side 10a. At the same time, cracks extend from modified layers 110 toward adjacent modified layers 110, and the modified layers 110 and the cracks make up the second peel-off layer 110A, as illustrated in FIG. 3B. The second peel-off layer forming step of the wafer manufacturing method according to the first embodiment is now completed. Laser processing conditions in the second peel-off layer forming step are as follows:

### Laser Processing Conditions in the Second Peel-Off Layer Forming Step

Wavelength: 1064 nm
Average output level: 7 to 16 W
Repetitive frequency: 30 kHz
Pulse duration: 3 ns
Processing feed speed: 165 mm/s
Defocusing distance: 260 µm (for forming a second peel-off layer 110A at a depth of 700 µm from the face side 10a)

After the first peel-off layer 100A and the second peel-off layer 110A have been formed respectively in the first peel-off layer forming step and the second peel-off layer forming step, a separating wall forming step of the wafer manufacturing method according to the first embodiment is performed as follows:

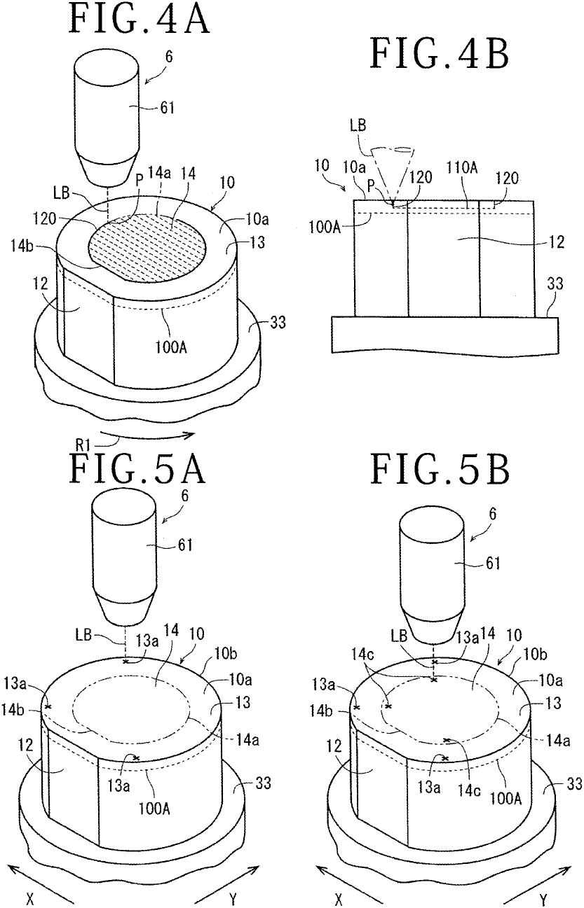

In the separating wall forming step, as illustrated in FIGS. 4A and 4B, the laser beam applying unit 6 applies the laser beam LB to an annular area in the ingot 10 along the outer circumferential edge 14a while positioning the focused spot P on the annular area of the ingot 10 on the basis of the positional information of the outer circumferential edge 14a stored in the controller, and the holding table 33 is rotated about its central axis in a direction indicated by an arrow R1 (see FIG. 4A), thereby forming an annular first separating wall 120 along the outer circumferential edge 14a in the ingot 10. For forming a straight section of the first separating wall 120 on the orientation flat 14b on the outer circumferential edge 14a, the holding table 33 stops from being rotated, and the X-axis moving mechanism 41 is actuated to processing-feed the holding table 33 in one of the X-axis directions. At the same time, the laser beam LB is applied to the orientation flat 14b on the outer circumferential edge 14a, thereby forming the straight section of the first separating wall 120 on the orientation flat 14b. It is preferable to form the first separating wall 120 in the ingot 10 with the laser beam LB by changing the depth at which the focused spot P is positioned vertically a plurality of times, thereby forming modified layers at a plurality of different depths in the ingot 10. According to the present embodiment, the depth of the focused spot P from the face side 10a is changed successively from 500 µm to 375 µm, 250 µm, and 125 µm to form four modified layers in the ingot 10 along the outer circumferential edge 14a, thereby forming the first separating wall 120 in the annular area along the outer circumferential edge 14a that reaches the second peel-off layer 110A. The separating wall forming step is now completed. Laser processing conditions in the separating wall forming step are as follows:

### <Laser Processing Conditions in the Separating Wall Forming Step>

Wavelength: 1064 nm
Average output level: 7 to 16 W
Repetitive frequency: 30 kHz
Pulse duration: 3 ns
Processing feed speed: 165 mm/s
Defocusing distances: 200 µm, 150 µm, 100 µm, 50 µm (for forming modified layers respectively at depths of 500 µm, 375 µm, 250 µm, 125 µm from the face side 10a).

According to the first embodiment described above, the first peel-off layer forming step, the second peel-off layer forming step, and the separating wall forming step are carried out successively. According to the present invention, the first peel-off layer forming step may be preceded or followed by a first alignment mark forming step of forming alignment marks in the ingot 10 that will be required in constructing circuits on the larger-diameter wafer 13. As illustrated in FIG. 5A, the alignment marks are alignment marks 13a for identifying the X-axis directions and the Y-axis directions required in constructing circuits on the larger-diameter wafer 13 to be separated and fabricated in a wafer fabricating step to be described later, after the first peel-off layer 100A has been formed in the first peel-off layer forming step. The alignment marks 13a should preferably include two alignment marks for identifying the X-axis directions and two alignment marks for identifying the Y-axis directions. According to the present embodiment, a total of three alignment marks 13a are formed.

The alignment marks 13a are formed as modified layers in the larger-diameter wafer 13 by the laser beam LB applied under laser processing conditions similar to the laser processing conditions adopted in the separating wall forming step described above. Each of the alignment marks 13a is shaped as “+” as viewed in plan, for example. The alignment marks 13a are formed in an excessive outer circumferential portion of the larger-diameter wafer 13 near the contour 10b of the ingot 10, where no circuits will be constructed, so that the alignment marks 13a will not obstruct the formation of circuits, etc. in the larger-diameter wafer 13. Although the first alignment mark forming step may be carried out before or after the first peel-off layer forming step, the first alignment mark forming step should preferably be performed after the first peel-off layer forming step in order not to interfere with the formation of the first peel-off layer 100A.

The alignment marks 13a formed in the first alignment mark forming step are not limited to the details described above. The alignment marks 13a may be formed by way of ablation by applying the laser beam LB to the ingot 10 while positioning the focused spot P of the laser beam LB on the face side 10a of the ingot 10. If the alignment marks 13a are thus formed by way of ablation, then it is preferable to ablate the ingot 10 to a depth large enough to keep the alignment marks 13a unremoved when the larger-diameter wafer 13 is subsequently ground and polished.

In addition, the second peel-off layer forming step may be preceded or followed by a second alignment mark forming step of forming alignment marks in the ingot 10 that will be required in constructing circuits on the smaller-diameter wafer 14. As illustrated in FIG. 5B, the alignment marks are alignment marks 14c for identifying the X-axis directions and the Y-axis directions required in constructing circuits on the smaller-diameter wafer 14 to be separated and fabricated in the wafer fabricating step to be described later, after the second peel-off layer 110A has been formed in the second peel-off layer forming step. The alignment marks 14c should preferably include at least a total of three alignment marks 14c for identifying the X-axis directions and the Y-axis directions, as is the case with the alignment marks 13a.

The alignment marks 14c are formed as modified layers in the smaller-diameter wafer 14 by the laser beam LB applied under laser processing conditions similar to the laser processing conditions adopted in the first alignment mark forming step described above. Each of the alignment marks 14c is shaped as “+” as viewed in plan, for example, as with the alignment marks 13a. The alignment marks 14c are formed in an excessive outer circumferential portion of the smaller-diameter wafer 14, where no circuits will be constructed, so that the alignment marks 14c will not obstruct the formation of circuits, etc. in the smaller-diameter wafer 14. Although the second alignment mark forming step may be carried out before or after the second peel-off layer forming step, the second alignment mark forming step should preferably be performed after the second peel-off layer forming step in order not to interfere with the formation of the second peel-off layer 110A.

The alignment marks 14c may be formed by way of ablation by applying the laser beam LB to the ingot 10 while positioning the focused spot P of the laser beam LB on the face side 10a of the ingot 10, as with the alignment marks 13a. The alignment marks 13a and 14c thus formed by the laser beam LB in the respective first and second alignment mark forming steps make it unnecessary to use a separate apparatus for forming alignment marks by way of exposure and etching, resulting in increased wafer productivity.

After the first peel-off layer forming step, the second peel-off layer forming step, the separating wall forming step, and the first and second alignment mark forming steps have been carried out, a wafer fabricating step, to be described below, is carried out.

The wafer fabricating step is a step of peeling off the larger-diameter wafer 13 from the ingot 10 along the first peel-off layer 100A as a peel-off initiating point and separating the smaller-diameter wafer 14 from the larger-diameter wafer 13 along the second peel-off layer 110A and the first separating wall 120 as separation initiating points. The wafer fabricating step can be carried out by the wafer peeling unit 8 illustrated in FIG. 1, for example. For carrying out the wafer fabricating step, the moving mechanism 4 of the laser processing apparatus 1 is actuated to move the holding table 33 until the face side 10a of the ingot 10 held on the holding table 33 is positioned directly below the suction disk 84 of the wafer peeling unit 8. Then, the Z-axis moving mechanism, not illustrated, housed in the peeling unit case 81 is actuated to lower the peeling unit arm 82 and the suction disk 84 until the suction disk 84 is pressed against the face side 10a of the ingot 10. Then, a negative pressure is developed in the suction holes in the suction disk 84, enabling the suction disk 84 to attract and hold the face side 10a of the ingot 10 under suction.

While the suction disk 84 is holding the face side 10a of the ingot 10 under suction, the stepping motor 83 is energized to rotate the suction disk 84, thereby twisting the first peel-off layer 100A to peel off the larger-diameter wafer 13 integral with the smaller-diameter wafer 14 from the ingot 10. After the larger-diameter wafer 13 integral with the smaller-diameter wafer 14 has been peeled off from the ingot 10, another peeling means, not illustrated, is used to separate the smaller-diameter wafer 14 from the larger-diameter wafer 13 along the second peel-off layer 110A and the first separating wall 120. As illustrated in FIG. 6, the larger-diameter wafer 13 has a thin layer 13a having a thickness of 100 µm left in a central portion thereof after the smaller-diameter wafer 14 has been separated from the larger-diameter wafer 13. Face and reverse sides of the larger-diameter wafer 13 and the smaller-diameter wafer 14 thus fabricated from the ingot 10 are polished to a mirror finish before circuits are constructed on the larger-diameter wafer 13 and the smaller-diameter wafer 14. The wafer fabricating step now comes to an end, completing the wafer manufacturing method according to the first embodiment.

According to the first embodiment described above, the smaller-diameter wafer 14 having the diameter of 200 mm can be fabricated from the larger-diameter wafer 13 that is fabricated from the ingot 10 and has the diameter of 300 mm. Therefore, the material of the ingot 10 is prevented from being wasted. In addition, it is also possible to fabricate a smaller-diameter wafer having a diameter of 150 mm from the smaller-diameter wafer 14 having the diameter of 200 mm according to a wafer manufacturing method similar to the above method performed on the smaller-diameter wafer 14. The material of the ingot 10 is thus further prevented from being wasted.

As illustrated in FIG. 6, when the larger-diameter wafer 13 and the smaller-diameter wafer 14 have been fabricated from the ingot 10 by the wafer manufacturing method according to the present embodiment, a newly created face side 10a of the ingot 10 is a rough surface. Before another larger-diameter wafer 13 and another smaller-diameter wafer 14 are fabricated from the ingot 10, therefore, separate polishing means is used to polish the face side 10a of the ingot 10 to a mirror finish.

The present invention is not limited to the first embodiment described above and is also applicable to a second embodiment to be described below.

According to the second embodiment, an ingot 10 similar to the ingot 10 according to the first embodiment is prepared, and the first peel-off layer forming step according to the first embodiment is carried out to form the first peel-off layer 100A in the ingot 10 at the first depth of 800 µm, for example, from the face side 10a of the ingot 10 for the fabrication of the larger-diameter wafer 13, as illustrated in FIGS. 2A and 2B. Then, a second peel-off layer forming step is carried out as follows: As illustrated in FIG. 7A, the laser beam applying unit 6 applies the laser beam LB to an entire area of the ingot 10 diametrically inward of an inner circumferential edge 11a of an annular stiffener 11 formed along an outer circumferential portion of the larger-diameter wafer 13 to be fabricated that is larger in diameter than the smaller-diameter wafer 14 to be fabricated, from the face side 10a of the ingot 10 while positioning the focused spot P of the laser beam LB at the second depth of 700 µm from the face side 10a, thereby forming modified layers 110′. The modified layers 110′ and cracks extending therefrom jointly make up a second peel-off layer 110′A in the ingot 10, as illustrated in FIG. 7B. Laser processing conditions under which the laser beam LB is applied to create the second peel-off layer 110′A in the ingot 10 are identical to those used to form the modified layers 110 according to the first embodiment.

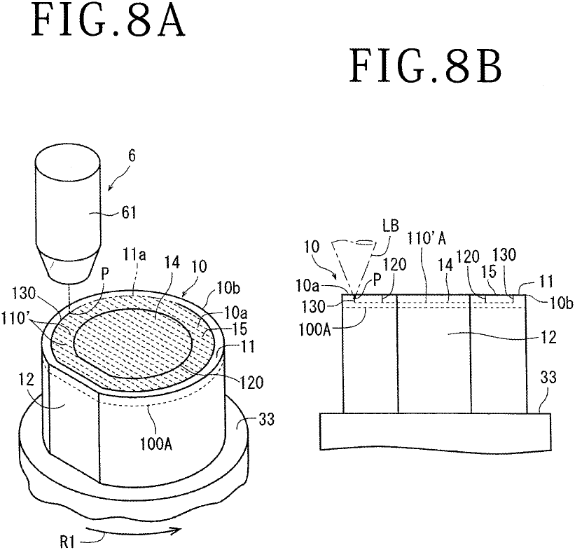

After the above second peel-off layer forming step has been carried out, as illustrated in FIGS. 8A and 8B, a separating wall forming step is carried out to form an annular second separating wall 130 in the ingot 10 along the inner circumferential edge 11a of the annular stiffener 11 in addition to the first separating wall 120 formed in the separating wall forming step according to the first embodiment. The second separating wall 130 is formed by the laser beam LB applied under laser processing conditions identical to those used to form the first separating wall 120 and according to processing details identical to those used to form the first separating wall 120. Specifically, the laser beam LB is applied to the ingot 10 along the inner circumferential edge 11a of the annular stiffener 11 while positioning the focused spot P on the inner circumferential edge 11a, thereby forming the annular second separating wall 130 in the ingot 10 along the inner circumferential edge 11a of the annular stiffener 11.

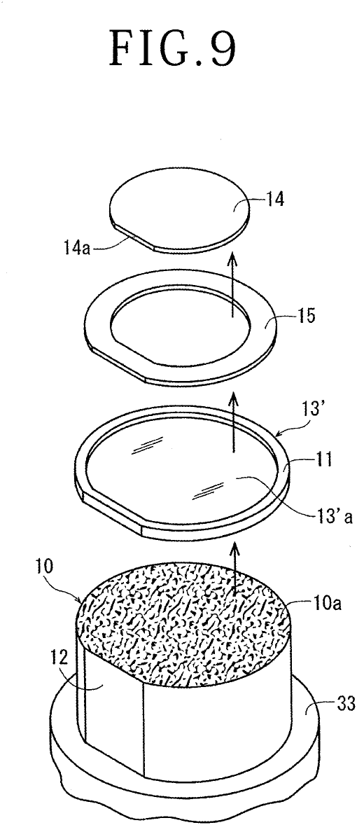

After the first peel-off layer forming step, the second peel-off layer forming step, and the separating wall forming step according to the second embodiment have been carried out, the wafer peeling unit 8 is used to carry out a wafer fabricating step that is essentially the same as the wafer fabricating step of the wafer manufacturing method according to the first embodiment. When the wafer fabricating step has been performed, the wafer manufacturing method according to the second embodiment is completed. Since the wafer manufacturing method according to the second embodiment includes the second peel-off layer forming step and the separating wall forming step described above, a larger-diameter wafer 13′ including the annular stiffener 11, the smaller-diameter wafer 14, and a ring-shaped wafer 15 from an area of the ingot 10 between the smaller-diameter wafer 14 and the annular stiffener 11 of the larger-diameter wafer 13′ are fabricated from the ingot 10 as illustrated in FIG. 9.

The larger-diameter wafer 13′ manufactured according to the second embodiment has a thin layer 13′a that is wider than the thin layer 13a provided according to the first embodiment because the smaller-diameter wafer 14 and the ring-shaped wafer 15 have been separated from the larger-diameter wafer 13′. Although the thin layer 13′a, which has a thickness of 100 µm, of the larger-diameter wafer 13′ is relatively wide as the smaller-diameter wafer 14 and the ring-shaped wafer 15 have been separated, the thin layer 13′a can be handled with ease because it is reinforced by the annular stiffener 11. The ring-shaped wafer 15 according to the second embodiment will be disposed of.

A wafer manufacturing method according to a third embodiment of the present invention will be described below. According to the first and second embodiments described above, the larger-diameter wafer 13 or the larger-diameter wafer 13′ and the smaller-diameter wafer 14 are manufactured from the ingot 10. According to the third embodiment, as illustrated in FIG. 10, a smaller-diameter wafer 25 is fabricated from a larger-diameter wafer 20 with a plurality of devices 22 constructed on a face side 20a thereof.

Prior to carrying out the wafer manufacturing method according to the third embodiment, the larger-diameter wafer 20 illustrated in a right section of FIG. 10 is prepared. The larger-diameter wafer 20 is a wafer of SiC having a diameter of 300 mm and a thickness of 800 µm. The larger-diameter wafer 20 has a plurality of areas demarcated on the face side 20a by a grid of projected dicing lines 24, with the devices 22 disposed in the respective demarcated areas. The larger-diameter wafer 20 has an orientation flat 20c on its outer circumferential surface as an indicator of its crystal orientation. Then, a protective tape T similar in shape and size to the larger-diameter wafer 20 is affixed to and integrally combined with the face side 20a, which is facing upwardly in FIG. 10, of the larger-diameter wafer 20. The larger-diameter wafer 20 with the protective tape T is inverted to have its reverse side 20b facing upwardly and the protective tape T facing downwardly, and placed on and fixed to the upper surface of the holding table 33 of the laser processing apparatus 1 (see FIG. 1) described above by an adhesive or the like.

After the larger-diameter wafer 20 has been fixed to the holding table 33, a smaller-diameter peel-off layer forming step that is essentially the same as the second peel-off layer forming step according to the second embodiment described above with reference to FIGS. 7A and 7B is carried out. For carrying out the smaller-diameter peel-off layer forming step, the image capturing unit 7 of the laser processing apparatus 1 captures an image of the larger-diameter wafer 20, and the shape of the larger-diameter wafer 20 and the height of the reverse side 20b are detected from the captured image. Then, as illustrated in FIG. 10, the wafer 20 is positioned directly below the beam condenser 61 of the laser beam applying unit 6. Then, the focused spot P of the laser beam LB whose wavelength is transmittable through SiC that the larger-diameter wafer 20 is made of is positioned at a depth of 700 µm, for example, corresponding to the thickness of the smaller-diameter wafer 25 to be fabricated, from the reverse side 20b of the larger-diameter wafer 20. The laser beam LB is applied to the larger-diameter wafer 20, and the moving mechanism 4 is actuated to form modified layers similar to the modified layers 110 described above in an entire area diametrically inward of an inner circumferential edge 21a of an annular stiffener 21 formed along an outer circumferential portion of the larger-diameter wafer 20, the entire area being larger in diameter than the smaller-diameter wafer 25 that has an outer circumferential edge 25a. The modified layers thus formed and cracks extending therefrom jointly make up a smaller-diameter peel-off layer 140. The smaller-diameter peel-off layer 140 is formed under laser processing conditions identical to those in the second peel-off layer forming step of forming the modified layers 110 and 110′.

The smaller-diameter peel-off layer forming step described above is followed by a smaller-diameter separating wall forming step of forming an annular smaller-diameter separating wall in the larger-diameter wafer 20 along the outer circumferential edge 25a of the smaller-diameter wafer 25 by applying the laser beam LB to the smaller-diameter wafer 25 while positioning the focused spot P in an annular area extending from the reverse side 20b of the larger-diameter wafer 20 to the smaller-diameter peel-off layer 140, and a smaller-diameter wafer fabricating step of fabricating the smaller-diameter wafer 25 from the smaller-diameter peel-off layer 140 and the smaller-diameter separating wall. The smaller-diameter separating wall forming step is carried out under laser processing conditions identical to those in the separating wall forming step described above with reference to FIGS. 4A and 4B and according to processing details identical to those in the separating wall forming step described above with reference to FIGS. 4A and 4B. The smaller-diameter separating wall is formed on the outer circumferential edge 25a as is the case with the first separating wall 120 described above and will not be described in detail below.

In the smaller-diameter separating wall forming step according to the third embodiment, another annular separating wall is formed in an area along the inner circumferential edge 21a of the annular stiffener 21. The separating wall formed in the area along the inner circumferential edge 21a of the annular stiffener 21 is a separating wall formed under laser processing conditions identical to those used to form the annular second separating wall 130 in the separating wall forming step according to the second embodiment and according to processing details identical to those used to form the annular second separating wall 130 in the separating wall forming step according to the second embodiment. Details of the separating wall formed in the area along the inner circumferential edge 21a of the annular stiffener 21 will not be described below.

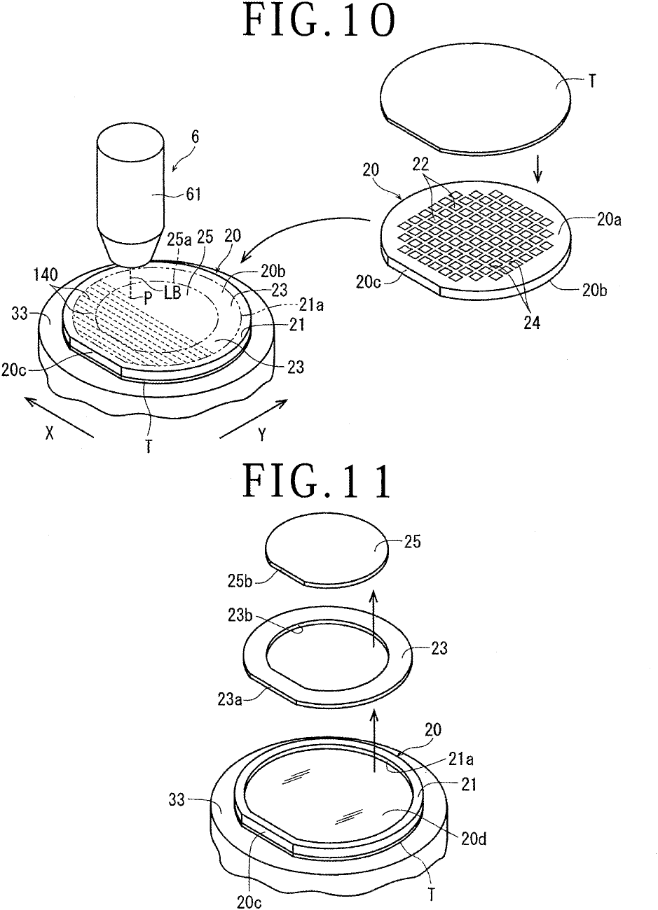

After the smaller-diameter peel-off layer forming step and the smaller-diameter separating wall forming step have been carried out, a smaller-diameter wafer fabricating step is carried out according to processing details similar to those in the wafer fabricating step according to the second embodiment to fabricate, as illustrated in FIG. 11, in addition to the larger-diameter wafer 20 having the annular stiffener 21 and the smaller-diameter wafer 25 having an orientation flat 25b, a ring-shaped wafer 23 from an area of the larger-diameter wafer 20 between the smaller-diameter wafer 25 and the annular stiffener 21 of the larger-diameter wafer 20, the ring-shaped wafer 23 having an orientation flat 23a and an opening 23b. The smaller-diameter wafer 25 has a thickness of 700 µm, and the larger-diameter wafer 20 has a thin layer 20d having a thickness of 100 µm diametrically inward of the annular stiffener 21. The ring-shaped wafer 23 according to the third embodiment will be disposed of.

According to the third embodiment, the smaller-diameter peel-off layer forming step may be preceded or followed by an alignment mark forming step of forming alignment marks inside or outside of the smaller-diameter wafer 25 that will be required in constructing circuits on the smaller-diameter wafer 25. The alignment mark forming step is a step of forming alignment marks similar to the alignment marks 14c described above with reference to FIG. 5B, and will not be described in detail below as it is identical to the second alignment mark forming step described above.

According to the third embodiment described above, the reverse side 20b of the larger-diameter wafer 20 having the diameter of 300 mm with the devices 22 constructed in the respective areas demarcated on the face side 20a by the projected dicing lines 24 is not ground, but the laser beam LB is applied to the larger-diameter wafer 20 from the reverse side 20b thereof to form the smaller-diameter peel-off layer 140, making it possible to fabricate the smaller-diameter wafer 25 having the thickness of 700 µm and the diameter of 200 mm that would otherwise be wasted. Therefore, the wafer manufacturing method according to the third embodiment is advantageous in that it can manufacture wafers economically. Furthermore, since the wafer manufacturing method according to the third embodiment includes the alignment mark forming step carried out by applying the laser beam LB to the larger-diameter wafer 20, it is not necessary to use a separate apparatus for forming alignment marks by way of exposure and etching, resulting in increased wafer productivity.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A wafer manufacturing method of manufacturing a wafer from an ingot, comprising:
a first peel-off layer forming step of forming a first peel-off layer in the ingot by applying a laser beam having a wavelength transmittable through the ingot while positioning a focused spot of the laser beam in the ingot at a first depth from an end face of the ingot for fabricating a larger-diameter wafer;
a second peel-off layer forming step of forming a second peel-off layer in the ingot for fabricating a smaller-diameter wafer by applying the laser beam to an area of the ingot that is smaller in diameter than the ingot while positioning the focused spot in the ingot at a second depth, which is smaller than the first depth, from the end face of the ingot;
a separating wall forming step of forming an annular first separating wall along an outer circumferential edge of the smaller-diameter wafer by applying the laser beam to the ingot while positioning the focused spot on an annular area extending from the end face of the ingot to the second peel-off layer; and
a wafer fabricating step of peeling off the larger-diameter wafer from the first peel-off layer and separating the smaller-diameter wafer from the second peel-off layer and the first separating wall.

2. The wafer manufacturing method according to claim 1,
wherein the second peel-off layer formed in the second peel-off layer forming step is also formed in an area of the ingot that is larger in diameter than the smaller-diameter wafer to be fabricated and that is positioned diametrically inward of an annular stiffener formed on an outer circumferential portion of the larger-diameter wafer to be fabricated,
the separating wall forming step includes a step of forming an annular second separating wall along an inner circumferential edge of the annular stiffener in addition to the first separating wall, and
the wafer fabricating step includes a step of fabricating a ring-shaped wafer from an area of the ingot between the smaller-diameter wafer and the annular stiffener.

3. The wafer manufacturing method according to claim 1, wherein the smaller-diameter wafer has a standardized diameter.

4. The wafer manufacturing method according to claim 2, wherein the ring-shaped wafer is to be disposed of after it has been fabricated from the ingot.

5. The wafer manufacturing method according to claim 1, further comprising:
a first alignment mark forming step of forming a first alignment mark inside or outside of the larger-diameter wafer that will be required in constructing circuits on the larger-diameter wafer to be fabricated, before or after the first peel-off layer forming step; and
a second alignment mark forming step of forming a second alignment mark inside or outside of the smaller-diameter wafer that will be required in constructing circuits on the smaller-diameter wafer to be fabricated, before or after the second peel-off layer forming step.

6. A wafer manufacturing method of manufacturing a smaller-diameter wafer from a larger-diameter wafer having a plurality of devices formed on a face side thereof, comprising:
a smaller-diameter peel-off layer forming step of forming a smaller-diameter peel-off layer in the smaller-diameter wafer to be fabricated, by applying a laser beam having a wavelength transmittable through the larger-diameter wafer while positioning a focused spot of the laser beam in the larger-diameter wafer at a depth from a reverse side thereof, the depth corresponding to a thickness of the smaller-diameter wafer to be fabricated;
a smaller-diameter separating wall forming step of forming an annular smaller-diameter separating wall in the larger-diameter wafer along an outer circumferential edge of the smaller-diameter wafer by applying the laser beam to the larger-diameter wafer while positioning the focused spot on an annular area extending from the reverse side of the larger-diameter wafer to the smaller-diameter peel-off layer; and
a smaller-diameter wafer fabricating step of separating the smaller-diameter wafer from the smaller-diameter peel-off layer and the smaller-diameter separating wall.

7. The wafer manufacturing method according to claim 6,
wherein the smaller-diameter peel-off layer formed in the smaller-diameter peel-off layer forming step is also formed in an area of the larger-diameter wafer that is larger in diameter than the smaller-diameter wafer to be fabricated and that is positioned diametrically inward of an annular stiffener formed on an outer circumferential portion of the larger-diameter wafer to be fabricated,
the smaller-diameter separating wall forming step includes a step of forming an annular separating wall along an inner circumferential edge of the annular stiffener in addition to the smaller-diameter separating wall along the outer circumferential edge of the smaller-diameter wafer, and
the wafer fabricating step includes a step of fabricating a ring-shaped wafer from an area of the larger-diameter wafer between the smaller-diameter wafer and the annular stiffener, in addition to the smaller-diameter wafer.

8. The wafer manufacturing method according to claim 7, wherein the ring-shaped wafer is to be disposed of after it has been fabricated from the larger-diameter wafer.

9. The wafer manufacturing method according to claim 6, further comprising:
an alignment mark forming step of forming an alignment mark inside or outside of the smaller-diameter wafer that will be required in constructing circuits on the smaller-diameter wafer to be fabricated, before or after the smaller-diameter peel-off layer forming step.
